(19) United States
(12) Patent Application Publication
(10) Pub. No.: US 2011/0089114 A1
(43) Pub. Date: Apr. 21, 2011

(54) PROCESS FOR ABSORBING AND ADSORBING OIL DEGRADATION PRODUCTS FROM LUBRICATING OILS

(76) Inventors: Gregory J. Livingstone, Tucson, AZ (US); Brian T. Thompson, La Grange, KY (US); David L. Woonton, Beaverdam, VA (US)

(21) Appl. No.: 12/761,081

(22) Filed: Apr. 15, 2010

Related U.S. Application Data
(60) Provisional application No. 61/169,964, filed on Apr. 16, 2009.

(51) Int. Cl. B01D 15/04; C07C 7/12

(52) U.S. Cl. 210/683; 585/823; 210/660; 210/502.1; 210/483

(57) ABSTRACT

Disclosed in certain embodiments is a method of removing a compound from a lubricating fluid comprising contacting the lubricating fluid with a solid medium having acrylamide functionality to absorb or adsorb the compound.

### PRIORITY

This application claims priority to U.S. Provisional Application No. 61/169,964, filed Apr. 16, 2009, the disclosure of which is hereby incorporated by reference in its entirety.

### FIELD OF THE INVENTION

The present invention is directed to a process for removing degraded materials, e.g., oxidation by-products from fluids such as lubricating and hydraulic fluids.

### BACKGROUND OF INVENTION

Lubricating oils undergo thermal and mechanical stresses that cause their additives and basestock to degrade. This chemical process changes the original molecules that make up the lubricant into less stable and less soluble degradation by-products. These degradation by-products can exist in either a dissolved or suspended form depending upon the chemistry and temperature of the lubricant. When the by-products are in a suspended state, they are at risk of settling out of the lubricant and forming deposits in sensitive areas of critical lubrication or hydraulic systems. These deposits are also commonly referred to as sludge and varnish.

Some lubrication systems are designed with multiple temperature zones and flow regimes throughout the system. When the fluid degrades, this means that the degradation by-products may be in solution in the reservoir where the fluid is warm, but in a suspended state in cooler parts of the system, such as infrequently used servo-valves and other low flow zones. In this situation, varnishes and deposits may form in these sensitive servo-valves risking the performance, reliability and safety of the entire system.

Suspended oil degradation products are typically sub-micron in size. Technologies such as electrostatic oil cleaning and some depth media filters have been used with moderate success at removing the suspended oil degradation products, however they are limited in their ability to remove degradation products in solution.

U.S. Patent Application Publication No. 2009/0001023 describes removing soluble degradation by-products in lubricating oils using a polystyrene resin. It was found however that the polystyrene resin could easily oxidize when stored at room temperature. In addition to creating a toxic amine gas, the oxidized resins created several performance and aesthetic problems.

Phosphate ester fluids are used as fire resistant fluids due to their inherent flame suppression properties and high flash and fire points. They are commonly used as a hydraulic medium in steam turbine electro-hydraulic control systems, metal processing plants, Navy ship aircraft elevators and other environments where there is a risk of fire.

Phosphate ester fluids break down through hydrolysis in the presence of water and oxidize when exposed to air and heat. The degradation by-products that form are acids that impact the fluid's ability to lubricate, protect the system and act as a hydraulic medium.

U.S. Pat. No. 5,661,117, U.S. Pat. No. 6,358,895 and U.S. Patent Application Publication No. 2005/0077224 all discuss using an ion exchange resin process to remove degraded phosphate ester acids to prolong the life of phosphate ester fluids. It was found however that the polystyrene resin could easily oxidize when stored at room temperature. When oxidized resins treated phosphate ester fluids, they had a negative impact on the fluid's resistivity. When the resistivity of the fluid drops below 5 GOhm-cm, the fluid is at risk of electrokinetic wear causing servo-valve malfunction.

There exists a need in the art for a process for removing degradation by-products that does not have the limitations of the prior art.

There also exists a need in the art for a process for removing acids from phosphate ester fluids that does not have the limitations of the prior art.

All references cited herein are incorporated by reference in their entireties for all purposes.

### OBJECTS AND SUMMARY OF THE INVENTION

This invention uses a filter media with acrylamide functionality. The media may be used in an acrylic-based resin, as a fibrous filter, gel and/or other medium. The filter media has higher oxidation stability and has not been shown to produce toxic by-products when stored at room temperature. Furthermore, the performance of the filter media is higher than the previous patent application.

It is an object of certain embodiments of the present invention to provide a process that absorbs and adsorbs dissolved and suspended polar oxidation by-products, detergent contamination components and depleted additives from rust and oxidation inhibited lubricating and hydraulic oils.

It is an object of certain embodiments of the present invention to provide a filter media that absorbs and adsorbs dissolved and suspended polar oxidation by-products from lubricants that has high oxidative stability.

It is an object of certain embodiments of the present invention to provide a filter media that absorbs and adsorbs dissolved and suspended polar oxidation by-products from lubricants that has high capacity and efficiency.

It is an object of certain embodiments of the present invention to provide a filter media that absorbs and adsorbs dissolved and suspended polar oxidation by-products from lubricants that does not produce unpleasant odors after storage at room temperature.

It is an object of certain embodiments of the present invention to provide a filter media that absorbs and adsorbs dissolved and suspended polar oxidation by-products from lubricants that does not produce toxic amine by-products after storage at room temperature.

It is an object of certain embodiments of the present invention to provide a filter media that absorbs and adsorbs dissolved and suspended polar oxidation by-products from lubricants that does not transfer odorous amine by-products to the lubricant.

It is an object of certain embodiments of the present invention to provide a filter media that removes acids from phosphate ester fluids without having an adverse effect on the fluid's resistivity.

One or more of the above objects can be achieved by the present invention which in certain embodiments is directed to a method of removing a compound from a lubricating fluid comprising contacting the lubricating fluid with a solid medium having acrylamide functionality to absorb or adsorb the compound.

In certain embodiments, the compound is an oil degradation product which can be soluble or insoluble. In preferred embodiments, the oil degradation product is an oxidation by-product.

In certain embodiments, the solid medium is incorporated in a resin, a fibrous filter or a gel.

In alternate embodiments, the solid medium having acrylamide functionality is a polymer. The polymer can be formed from monomers selected from, e.g., the group consisting of methyl acrylate, ethyl acrylate, isobutyl methacrylate, methyl methacrylate and mixtures thereof. The polymer can be selected from, e.g., the group consisting of (meth)acrylic ester/hydroxy(meth)alkyl ester copolymers, (meth)acrylic ester/glycidyl(meth)alkyl ester copolymers, (meth)acrylic ester/(meth)acrylic acid copolymers, (meth)acrylic ester/acrylamide copolymers and copolymer with divinyl benzene.

In certain embodiments, the method is practiced in-situ or off-line. The medium can be included in a removable cassette.

In certain embodiments, the solid medium is in bead form and can be, e.g., is a size range from about no. 10 to about no. 100 mesh. In certain embodiments, at least 50% of the beads have a size range from about no. 10 to about no. 100 mesh.

In certain embodiments, the solid medium is in a chemically activated fibrous material that is formed into a polymetric matrix. This material acts as an activated filter that exhibits similar functionality as the bead form. The fibrous material can be used as a cartridge or a cassette.

In certain embodiments, the lubricating fluid is non-polar and can be, e.g., hydraulic fluid, control fluid or another lubricating fluid.

In certain embodiments, the non-polar lubricating fluid is a hydrocarbon oil and the Membrane Patch Colorimetry (MPC) (currently a draft standard within ASTM under D02.C01 WK13070) of the hydrocarbon oil is 15 or lower after the process of the present invention.

In certain embodiments, the non-polar lubricating fluid is a turbine lubricating oil and the MPC of the turbine oil is 15 or lower after the process of the present invention.

In certain embodiments, the present invention is directed to a system comprising a plurality of interconnected parts with a flow of lubricating fluid to reduce friction on the parts, the system including a removable filter containing a solid medium having acrylamide functionality to adsorb or absorb oxidized by-products from the fluid.

### BRIEF DESCRIPTION OF THE FIGURES

FIG. 1 depicts a sectional view of a pipe in a cleaning loop of an embodiment of a lubricant system used in the present invention.

FIG. 2 depicts the results of Example 1.

FIG. 3 depicts the results of Example 2.

FIG. 4 depicts the results of Example 4.

### DETAILED DESCRIPTION

In some forms, the filter media comes wet. For example, when using the media in a resin form, it contains approximately 65% water. In order for the material to function optimally, the filter media is required to be dried. This can be accomplished in a variety of ways, such as chemical treatment or by passing dry air over the resin for a certain period of time. This can also be accomplished by circulating dry lubricating fluid through the media to allow it to be dried and optionally using a dryer to dry the fluid.

The invention can be practiced by passing the lubricant to be purified through the filter media, e.g., an acrylamide resin, for a length of time sufficient to remove an amount of degradation product.

When using the filter media in a resin form, the residence time of the fluid to filter media can be 1 US gallon per minute per 8.2 cubic feet of resin, plus or minus 20%, although any residence time sufficient to remove degradation product fall within the present invention. The process can be designed to be installed in situ and operated, e.g., in a kidney loop operation, but can also be utilized in various off-line scenarios.

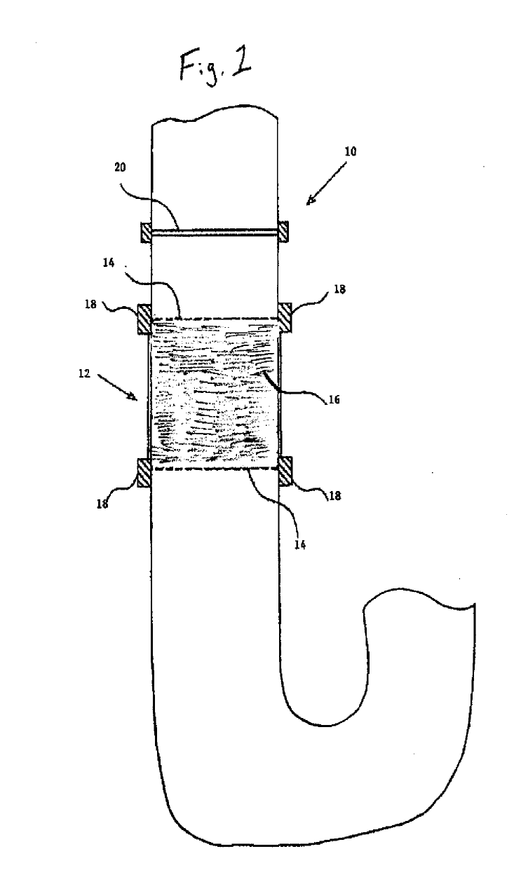

Referring to FIG. 1, a sectional view of a portion of pipe 10 typical of a cleaning loop in a lubricant system is shown in section with a cassette 12 in place. The cassette 12 is a section of the pipe in which two barriers 14, typically a pored screen or mesh, are positioned both upstream and downstream of a quantity of solid medium having acrylamide functionality (e.g., fibers) 16 according to the invention. The pores or mesh screen holes in the barrier 14 need only to be smaller than the smallest size of the medium 16 to hold them in their position within the cassette 12. The cassette 12 can be removed, for replacement of the medium 16, via threaded fasteners 18 or any other suitable means. A traditional particulate filter 20 can be in position downstream of the cassette 12. The section of pipe 10 can be placed in any convenient location in a lubricant system, preferably in a location of easy access for maintenance (e.g., replacement of the solid medium).

A non-limiting list of additional monomers that can be utilized in the present invention to form polymers includes N-methyl acrylamide, N-methyl methacrylamide, N-methyl ethacrylamide, N-methyl n-propylacrylamide, N-methyl isopropylacrylamide, N-methyl n-butyl acryl amide, N-methyl iso-butyl acryl amide, N-methyl tert-butyl acryl amide, N-methyl pentylacrylamide, N-methyl hexylacrylamide, N-ethyl acrylamide, N-ethyl methacrylamide, N-ethyl ethacrylamide, N-ethyl n-propylacrylamide, N-ethyl isopropylacrylamide, N-ethyl n-butylacryl amide, N-ethyl iso-butylacrylamide, N-ethyl tert-butylacrylamide, N-ethyl pentylacrylamide, N-ethyl hexylacrylamide, N-phenyl acrylamide, N-phenyl methacrylamide, N-phenyl ethacrylamide, N-methyl phenylacrylamide, N,N-di-methyl acrylamide, N,N-di-methyl methacrylamide, N,N-di-methyl ethacrylamide, N,N-di-methyl phenylacrylamide, N,N-di-phenyl acrylamide, N,N-di-phenyl methacrylamide, N,N-di-phenyl ethacrylamide, N,N-di-phenyl butylacrylamide, N-hydroxyphenyl acrylamide, N-hydroxyphenyl methacrylamide, N-hydroxyphenyl ethacrylamide, N-methyl hydroxyphenylacrylamide, N,N-di-methyl acrylamide, N,N-di-methyl methacrylamide, N,N-di-methyl ethacrylamide, N,N-di-methyl hydroxyphenylacrylamide, N,N-di-hydroxyphenyl acrylamide, N,N-di-hydroxyphenyl methacrylamide, N,N-di-hydroxyphenyl ethacrylamide, N,N-di-hydroxyphenyl butylacrylamide, N-styryl acrylamide, N-styryl methacrylamide, N-styryl ethacrylamide, N-methyl styryl acrylamide, N,N-di-methyl acrylamide, N,N-di-methyl methacrylamide, N,N-di-methyl ethacrylamide, N,N-di-methyl styrylacrylamide, N,N-di-styryl acrylamide, N,N-di-styryl methacrylamide, N,N-di-styryl ethacrylamide, N,N-di-styryl butylacrylamide, N-benzyl acrylamide, N-benzyl methacrylamide, N-benzyl ethacrylamide, N-methyl benzylacrylamide, N,N-di-methyl acrylamide, N,N-di-methyl methacrylamide, N,N-di-methyl ethacrylamide, N,N-di-methyl benzylacrylamide, N,N-di-benzyl acrylamide, N,N-di-benzyl methacrylamide, N,N-di-benzyl ethacrylamide, N,N-di-benzyl butylacrylamide, N,N-di-methyl acrylamide, N,N-di-ethyl acrylamide, N,N-di-n-propyl acrylamide, N,N-di-isopropylacrylamide, N,N-di-n-butyl acrylamide, N,N-di-isobutyl acrylamide, N,N-di-tert-butyl acrylamide, N,N-di-pentyl acrylamide, N,N-di-hexyl acrylamide, N,N-di-methyl methacrylamide, N,N-di-ethyl methacrylamide, N,N-di-n-propyl methacrylamide, N,N-di-isopropyl methacrylamide, N,N-di-n-butyl methacrylamide, N,N-di-isobutyl methacrylamide, N,N-di-tert-butyl methacrylamide, N,N-di-pentyl methacrylamide, N,N-di-hexyl methacrylamide, N,N-di-methyl ethacrylamide, N,N-di-ethyl ethacrylamide, N,N-di-n-propyl ethacrylamide, N,N-di-isopropyl ethacrylamide, N,N-di-n-butyl ethacrylamide, N,N-di-isobutyl ethacrylamide, N,N-di-tert-butyl ethacrylamide, N,N-di-pentyl ethacrylamide, N,N-di-hexyl ethacrylamide, N,N-di-methyl butylacrylamide, N,N-di-ethyl butylacrylamide, N,N-di-n-propyl butyl acrylamide, N,N-di-isopropyl butylacrylamide, N,N-di-n-butyl butyl acrylamide, N,N-di-isobutyl butylacrylamide, N,N-di-tert-butyl butylacrylamide, N,N-di-pentyl butylacrylamide, N,N-di-hexyl butylacrylamide, N,N-di-methyl propylacrylamide, N,N-di-ethyl propylacrylamide, N,N-di-n-propyl propylacrylamide, N,N-di-isopropyl propylacrylamide, N,N-di-n-butyl propylacrylamide, N,N-di-isobutyl propylacrylamide, N,N-di-tert-butyl propylacrylamide, N,N-di-pentyl propylacrylamide, propylacrylamide, and combinations thereof.

The lubricating fluids that can be utilized in the methods of the present invention include those manufactured using a variety of different processes including, but not limited to, distillation, solvent refining, hydrogen processing, oligomerization, esterification, and rerefining.

The base oil of the lubricating fluids utilized in the present invention may be any natural or synthetic lubricating base oil. Hydrocarbon synthetic oils include, but are not limited to, oils prepared from the polymerization of ethylene or from the polymerization of 1-olefins to provide polymers such as polyalphaolefin or PAO oils, or from hydrocarbon synthesis procedures using carbon monoxide and hydrogen gases such as in a Fischer-Tropsch process.

The fluid utilized in the present invention may be derived from natural lubricating oils, synthetic lubricating oils or mixtures thereof. Suitable oils include base stocks obtained by isomerization of synthetic wax and slack wax, as well as hydrocracked fluids produced by hydrocracking (rather than solvent extracting) the aromatic and polar components of the crude.

Other fluids that can be utilized in the present invention include those in all API categories I, II, III, IV and V as defined in API Publication 1509, 14th Edition, Addendum I, December 1998. Group IV base oils are polyalphaolefins (PAO). Group V base oils include all other base oils not included in Group I, II, III, or IV, e.g., polyol esters, polyalkylene glycols (PAG), and perfluoropolyalkylethers (PFPAEs).

Natural oils include mineral lubricating oils such as, for example, liquid petroleum oils, solvent-treated or acid-treated mineral lubricating oils of the paraffinic, naphthenic or mixed paraffinic-naphthenic types, oils derived from coal or shale, animal oils, vegetable oils (e.g., rapeseed oils, castor oils and lard oil), and the like.

Synthetic lubricating oils include, but are not limited to, hydrocarbon oils and halo-substituted hydrocarbon oils such as polymerized and interpolymerized olefins, e.g., polybutylenes, polypropylenes, propylene-isobutylene copolymers, chlorinated polybutylenes, poly(1-hexenes), poly(1-octenes), poly(1-decenes), and the like and mixtures thereof; alkylbenzenes such as dodecylbenzenes, tetradecylbenzenes, dinonylbenzenes, di(2-ethylhexyl)-benzenes, and the like; polyphenyls such as biphenyls, terphenyls, alkylated polyphenyls, and the like; alkylated diphenyl ethers and alkylated diphenyl sulfides and the derivative, analogs and homologs thereof and the like.

Other useful synthetic lubricating oils include, but are not limited to, oils made by polymerizing olefins of less than 5 carbon atoms such as ethylene, propylene, butylenes, isobutene, pentene, and mixtures thereof. Methods of preparing such polymer oils are well known to those skilled in the art.

Additional useful synthetic hydrocarbon oils include liquid polymers of alpha olefins having the proper viscosity. Especially useful synthetic hydrocarbon oils are the hydrogenated liquid oligomers of C₆ to C₁₂ alpha olefins such as, for example, 1-decene trimer.

Other synthetic lubricating oils include, but are not limited to, alkylene oxide polymers, i.e., homopolymers, interpolymers, and derivatives thereof where the terminal hydroxyl groups have been modified by, for example, esterification or etherification. These oils are exemplified by the oils prepared through polymerization of ethylene oxide or propylene oxide, the alkyl and phenyl ethers of these polyoxyalkylene polymers (e.g., methyl poly propylene glycol ether having an average molecular weight of 1,000, diphenyl ether of polyethylene glycol having a molecular weight of 500-1000, diethyl ether of polypropylene glycol having a molecular weight of 1,000-1,500, etc.) or mono- and polycarboxylic esters thereof such as, for example, the acetic esters, mixed C₃-C₉ fatty acid esters, or the C₁₃ oxo acid diester of tetraethylene glycol.

Another class of synthetic lubricating oils that can be utilized in the present invention include, but are not limited to, the esters of dicarboxylic acids e.g., phthalic acid, succinic acid, alkyl succinic acids, alkenyl succinic acids, maleic acid, azelaic acid, suberic acid, sebacic acid, fumaric acid, adipic acid, linoleic acid dimer, malonic acids, alkyl malonic acids, alkenyl malonic acids, etc., with a variety of alcohols, e.g., butyl alcohol, hexyl alcohol, dodecyl alcohol, 2-ethylhexyl alcohol, ethylene glycol, diethylene glycol monoether, propylene glycol, etc. Specific examples of these esters include dibutyl adipate, di(2-ethylhexyl)sebacate, hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, the complex ester formed by reacting one mole of sebacic acid with two moles of tetraethylene glycol and two moles of 2-ethylhexanoic acid and the like.

Esters useful as synthetic oils in the present invention include, but are not limited to, those made from carboxylic acids having from about 5 to about 12 carbon atoms with alcohols, e.g., methanol, ethanol, etc., polyols and polyol ethers such as neopentyl glycol, trimethylol propane, pentaerythritol, dipentaerythritol, tripentaerythritol, and the like.

Particularly preferred fluids that can be utilized in the present invention include ester-derived lubricants such as phosphate esters and polyol esters and the like.

Silicon-based oils that can be utilized in the present invention include, for example, polyalkyl-, polyaryl-, polyalkoxy- or polyaryloxy-siloxane oils and silicate oils, comprise another useful class of synthetic lubricating oils. Specific examples of these include, but are not limited to, tetraethyl silicate, tetra-isopropyl silicate, tetra-(2-ethylhexyl) silicate, tetra-(4-methyl-hexyl)silicate, tetra-(p-tert-butyl phenyl)silicate, hexyl-(4-methyl-2-pentoxy)disiloxane, poly(methyl)siloxanes, poly(methylphenyl)siloxanes, and the like. Still yet other useful synthetic lubricating oils include, but are not limited to, liquid esters of phosphorous containing acids, e.g., tricresyl phosphate, trioctyl phosphate, diethyl ester of decane phosphionic acid, etc., polymeric tetrahydrofurans and the like.

The lubricating oil utilized in the present invention may be derived from unrefined, refined and rerefined oils, either natural, synthetic or mixtures of two or more of any of these of the type disclosed hereinabove.

### EXAMPLES

To successfully measure the performance of the invention, the Membrane Patch Colorimetry (MPC) test can be used. The analysis involves storing a representative sample of used lubricant at room temperature for at least 96 hours. Then, 50 mLs of the lubricant are mixed with 50 mLs of petroleum ether and filtered through a 0.45-micron, 47 mm membrane. The color of the membrane is then measured and reported in the CIE LAB scale as DE (defined in ASTM E308).

The performance data of this filter media when properly configured and when appropriately sized and installed on a lubricating system demonstrates the rapid removal of by-products that are suspended and in solution. The DE values in the MPC test usually reach DE values of less than 10 within a few days of installation. The oil degradation products go into solution between 40 and 50° C.

### Example 1

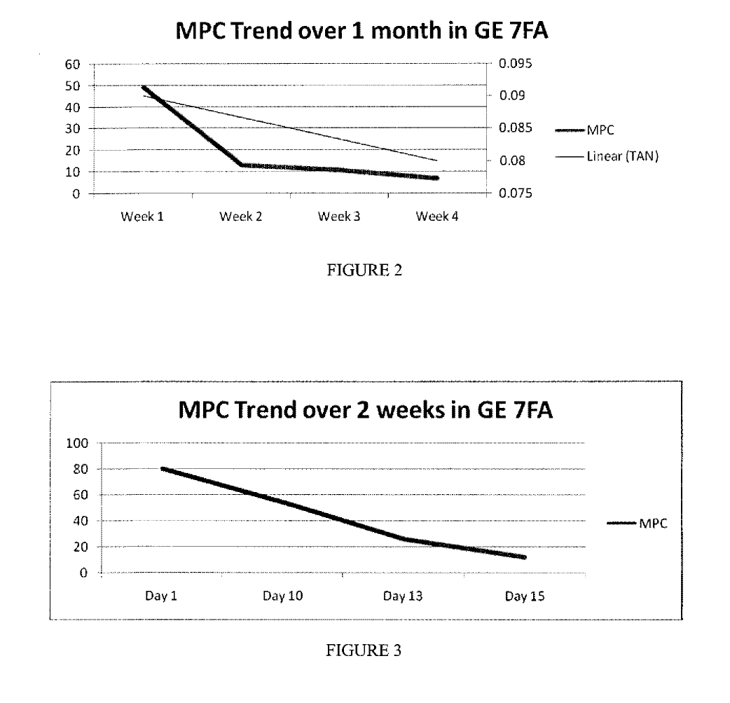

An ESP unit was installed with filter media possessing acrylimide functionality on an operating GE Frame 7FA gas turbine with approximately 6,200 gallons of Mobil DTE 832 operating at 43° C. The unit was installed for 1 month. The initial MPC value was 49DE and the MPC value at the end of test was 7DE. The data trend is shown in FIG. 2 and the details of the type and amounts of resin used are set forth below in Table 1.

TABLE 1

| | |
|---|---|
| Resin Type | Strong based, macroporous acrylic |
| | anion exchange resin |
| Resin Brand | Lewatit VP OC 1074 |
| Volume of Resin | 2.3 cubit feet |
| Used | |
| Flow Rate | 8.9 liters per minute |

This case study shows that ESP will remove oil degradation products that are both in suspension and in solution.

### Example 2

An ESP unit was installed with filter media possessing acrylimide functionality on an operating GE Frame 7FA gas turbine with approximately 6,200 gallons of Shell Turbo T 32 operating at 60° C. The unit was installed for two weeks. The oil was tested by a third party oil analysis company with a proprietary varnish test called Quantitative Spectrophotometric Analysis. (The QSA test is based on the MPC procedure and also measures oil degradation products in turbine oils.) The initial results had a QSA rating of 80. After approximately 2 weeks, the results were tracked in FIG. 3 and the type and amount of resin used are set forth below in Table 2.

TABLE 2

| | |
|---|---|
| Resin Type | Strong based, macroporous acrylic |
| | anion exchange resin |
| Resin Brand | Lewatit VP OC 1074 |
| Volume of Resin | 1.74 cubit feet |
| Used | |
| Flow Rate | 8.9 liters per minute |

The results show that ESP will remove oil degradation products that are in solution.

### Example 3

Oil was obtained from a Siemens SGT5-8000H gas turbine operating with Shell Turbo CC 46 turbine oil. Approximately 50 liters of oil was passed through ESP media at a temperature of 24 C. The MPC values per 50 liter pass of the ESP media was as follows:

| | |
|---|---|
| Start of Test | 33 |
| Pass 1 | 17 |
| Pass 2 | 13 |
| Pass 3 | 13 |
| Pass 4 | 11 |
| Pass 5 | 9 |

The type and amount of resin used is set forth in Table 3 below:

TABLE 3

| | |
|---|---|
| Resin Type | Strong based, macroporous acrylic |
| | anion exchange resin |
| Resin Brand | Lewatit VP OC 1074 |
| Volume of Resin | 0.58 cubit feet |
| Used | |
| Flow Rate | 2.2 liters per minute |

### Example 4

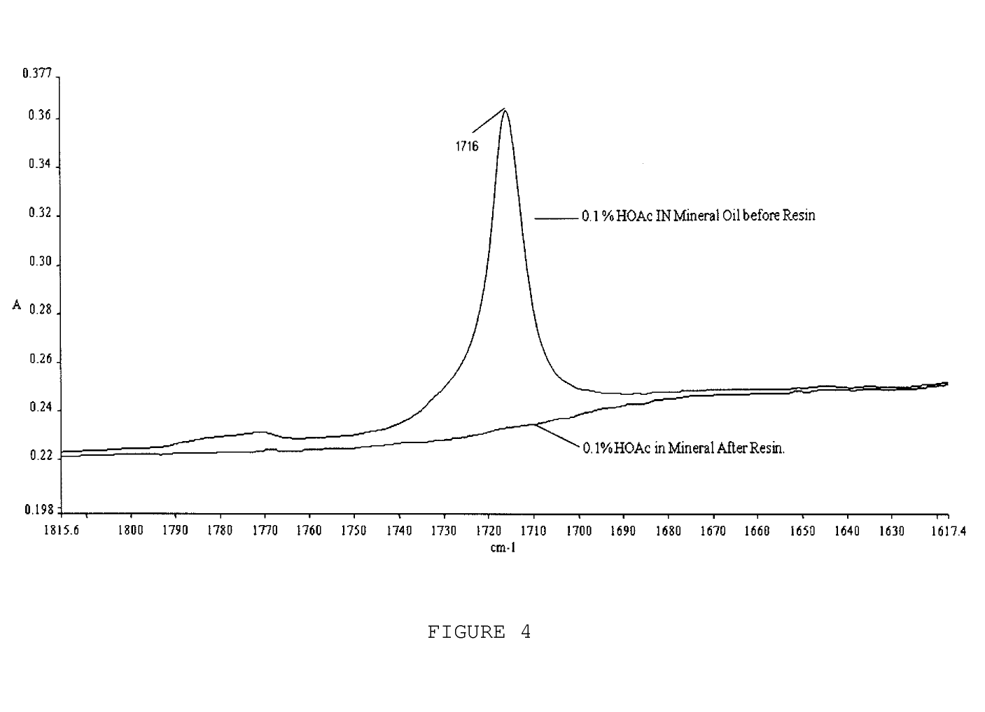

A blended sample containing 0.1 weight percent acetic acid in white oil (mineral oil) was analyzed for the content of acid by FTIR spectroscopy. The Peak Height measured at 1716 cm⁻¹ before Resin treatment was 0.12 Abs (corrected for baseline). The sample was filtered using a strong-basic acrylate resin. The resultant sample was analyzed for acid content by FTIR spectroscopy. The Peak Height measured at 1716 cm⁻¹ after Resin treatment was 0.00 Abs (corrected for baseline). The results are tracked in FIG. 4 and the type and amount of resin used is set forth in Table 4.

TABLE 4

| | |
|---|---|
| Resin Type | Strong based, macroporous acrylic |
| | anion exchange resin |
| Resin Brand | Lewatit VP OC 1074 |
| Volume of Resin | 0.005 cubit feet |
| Used | |
| Flow Rate | 5 ml per minute |

The strong-basic acrylate resin absorbed all the acetic acid from the mineral oil sample in a one pass experiment. The resultant sample contained no measurable acid after the resin treatment.

### Example 5

The ESP resins with acrylamide functionality were compared against the styrene resins outlined in US Patent Application Publication No. 2009/0001023 to measure the gaseous degradation products derived from oxidized resins.

A 5-gram portion of each resin was placed in individual headspace vials and analyzed via headspace gas chromatography-mass spectrometry (GC-MS). The sample vials were heated for 15 minutes at 160° C. after which the headspace vapor was transferred directly into the GC-MS via a headspace autosampler for analysis. Total ion chromatograms (TIC's) were obtained.

Results from experiment at 160° C.

| | Retention | Styrene based | Acrylamide |
|---|---|---|---|
| | Time, | resin | Based Resin |
| Chemistry | (mins) | (abundance) | (abundance) |
| Methylethylamine (2.0) | 2.0 | 172,000 | 34,000 |
| Chlorotoluene (8 | 8.2 | 8,000 | Not detectable |
| Chloroethenylbenzene | 10.7 | 7,500 | Not detectable |
| Methylene Dichloropropane | 15.5 | 13,000 | Not detectable |

The present invention is not to be limited in scope by the specific embodiments disclosed herein which are intended as illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims.

1. A method of removing a compound from a lubricating fluid comprising: contacting the lubricating fluid with a solid medium having acrylamide functionality to absorb or adsorb the compound.

2. The method of claim 1, wherein the compound is an oil degradation product.

3. The method of claim 2, wherein the oil degradation product is soluble or insoluble.

4. The method of claim 2, wherein the oil degradation product is an oxidation by-product or detergent contamination component.

5. The method according to claim 1, wherein the solid medium is incorporated in a resin, a fibrous filter or a gel.

6. The method according to claim 1, wherein said solid medium having acrylamide functionality is a polymer.

7. The method of claim 6, wherein said polymer is selected from the group consisting of (meth)acrylic ester/hydroxy(meth)alkyl ester copolymers, (meth)acrylic ester/glycidyl(meth)alkyl ester copolymers, (meth)acrylic ester/(meth)acrylic acid copolymers, (meth)acrylic ester/acrylamide copolymers and divinyl benzene copolymers.

8. The method according to claim 1, wherein the contacting is in-situ.

9. The method according to claim 1, wherein the contacting is off-line.

10. The method according to claim 1, wherein the solid medium is in bead form.

11. The method of claim 10, wherein the size of the beads range from about no. 10 to about no. 100 mesh.

12. The method of claim 10, wherein at least 50% of the beads have a size range from about no. 10 to about no. 100 mesh.

13. The method of claim 1, wherein the lubricating fluid is non-polar.

14. The method of claim 15, wherein the lubricating fluid is hydraulic fluid or control fluid.

15. The method of claim 13, wherein the non-polar lubricating fluid is a hydrocarbon oil.

16. The method of claim 15, wherein the MPC of said hydrocarbon oil is 12 or lower after the contacting.

17. The method of claim 15, wherein the non-polar lubricating fluid is a turbine lubricating oil.

18. The method of claim 17, wherein the MPC of said turbine lubricating oil is 8 or lower after the contacting.

19. The method of claim 1, wherein the solid medium is contained within a cassette.

20. The method of any of the preceding claims wherein the fluid is a phosphate ester

21. A system comprising a plurality of interconnected parts with a flow of lubricating fluid to reduce friction on the parts, the system including a removable filter containing a solid medium having acrylamide functionality to adsorb or absorb oxidized by-products from the fluid.

22. The system of claim 21, wherein the removable filter is included in a cassette.

23. The system of claim 21 or 22 wherein the fluid is a phosphate ester

24. A method of removing a compound from a phosphate ester fluid comprising: contacting phosphate ester fluid with a solid medium having acrylamide functionality to absorb or adsorb the compound.

25. The method of claim 1, wherein the compound is an acid.

26. The method of claim 15, wherein the MPC of said hydrocarbon oil is 10 or lower after the contacting.

27. The method of claim 1, wherein the solid medium comprises a strong-based anion exchange resin.
